(19) United States
(12) Patent Application Publication
(10) Pub. No.: US 2026/0352354 A1
(43) Pub. Date: Nov. 5, 2026

(54) TERMINAL, BASE STATION, RADIO COMMUNICATION SYSTEM, AND RADIO COMMUNICATION METHOD

(71) Applicant: NTT DOCOMO, INC., Tokyo (JP)

(72) Inventors: Tianyang Min, Tokyo (JP); Tadashi Uchiyama, Tokyo (JP)

(73) Assignee: NTT DOCOMO, INC., Tokyo (JP)

(21) Appl. No.: 19/488,392

(22) PCT Filed: Jun. 22, 2023
(86) PCT No.: PCT/JP2023/023230

§ 371 Date: Nov. 26, 2025

(51) Int. Cl. H04B 17/373

(52) U.S. Cl. CPC H04B 17/373

(57) ABSTRACT

A terminal includes: a control unit that identifies predicted information on radio resource management of the terminal; and a transmission unit that transmits the predicted information.

### TECHNICAL FIELD

The present disclosure relates to a terminal, a base station, a radio communication system, and a radio communication method that support AIML (Artificial Intelligence Machine Learning).

### BACKGROUND ART

The 3rd Generation Partnership Project (3GPP) has prepared a specification for the 5th generation mobile communication system (also called 5G, New Radio (NR), or Next Generation (NG) ) and is also preparing a next generation specification called Beyond 5G, 5G Evolution, or 6G.

For example, in 3GPP Release-17 , a framework of a RAN (Radio Access Network) that is realized by AI (Artificial Intelligence) is proposed (Non-Patent Literature 1). In addition, in 3GPP Release 19, studies on AI-based RRM (Radio Resource Management) measurements are being conducted for mobility optimization.

### CITATION LIST

### Non-Patent Literature

Non-Patent Literature 1: 3 GPP TR37.817 V17.0.0 3rd Generation Partnership Project; Technical Specification Group Radio Access Network; Evolved Universal Terrestrial Radio Access (E-UTRA) and NR; Study on enhancement for Data Collection for NR and EN-DC (Release 17), 3GPP, April 2022

### SUMMARY OF INVENTION

In the background described above, the inventors have found a need to clarify a concrete method of utilizing AI-based predicted information in radio resource management as a result of intensive investigation.

Thus, the disclosure is made in view of the above issue, and an object thereof is to provide a terminal, a base station, a radio communication system, and a radio communication method that are capable of optimizing radio resource management, based on AI-based predicted information.

An aspect of the present disclosure is a terminal including: a control unit that identifies predicted information on radio resource management of the terminal; and a transmission unit that transmits the predicted information.

An aspect of the present disclosure is a base station including: a control unit that assumes that a terminal identifies predicted information on radio resource management of the terminal; and a reception unit that receives the predicted information.

An aspect of the present disclosure is a radio communication system including: a terminal; and a base station, wherein the terminal includes: a control unit that identifies predicted information on radio resource management of the terminal; and a transmission unit that transmits the predicted information.

An aspect of the present disclosure is a radio communication method including: a step A of identifying predicted information on radio resource management of a terminal; and a step B for transmitting the predicted information.

### BRIEF DESCRIPTION OF DRAWINGS

FIG. 1 is an overall schematic configuration diagram of a radio communication system 10.

FIG. 2 is a diagram illustrating frequency ranges used in the radio communication system 10.

FIG. 3 is a diagram illustrating a configuration example of a radio frame, subframes, and slots used in the radio communication system 10.

FIG. 4 is a functional block diagram of a UE 200.

FIG. 5 is a functional block diagram of a gNB 100.

FIG. 6 is a diagram illustrating an AIML model.

FIG. 7 is a diagram illustrating operation example 1.

FIG. 8 is a diagram illustrating operation example 2.

FIG. 9 is a diagram illustrating operation example 3.

FIG. 10 is a diagram illustrating operation example 4.

FIG. 11 is a diagram illustrating operation example 5.

FIG. 12 is a diagram illustrating operation example 6.

FIG. 13 is a diagram illustrating operation example 7.

FIG. 14 is a diagram illustrating a hardware configuration example of the gNB 100 and the UE 200.

FIG. 15 is a diagram illustrating a configuration example of a vehicle 2001.

### DESCRIPTION OF EMBODIMENTS

Embodiments will be described below with reference to the drawings. Note that the same or similar reference numerals have been attached to the same functions and configurations, and descriptions thereof will be omitted as appropriate.

### Embodiment

### (1) Overall Schematic Configuration of Radio Communication System

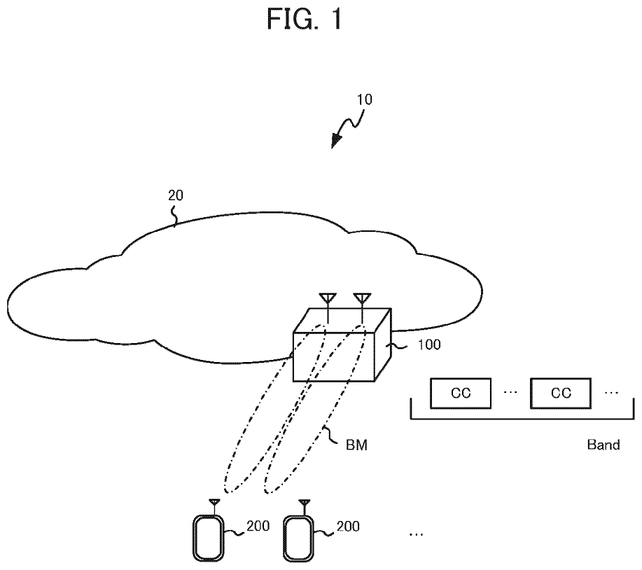

FIG. 1 is an overall schematic configuration diagram of a radio communication system 10 according to the embodiment. The radio communication system 10 is a 5G New Radio (NR) compliant radio communication system and includes a Next Generation-Radio Access Network 20 (hereinafter, NG-RAN 20 and a terminal 200 (hereinafter, UE (User Equipment) 200).

Note that the radio communication system 10 may be compliant with a radio communication system called Beyond 5G, 5G Evolution, or 6G.

The NG-RAN 20 includes a radio base station 100 (hereinafter, gNB 100). Note that the specific configuration of the radio communication system 10, including the number of the gNBs 100 and the UEs 200, is not limited to the example illustrated in FIG. 1.

The NG-RAN 20 actually includes multiple NG-RAN nodes, specifically gNBs (or ng-eNBs), and is connected to a 5G-compliant core network (5GC, not illustrated). Note that the NG-RAN 20 and 5GC may be expressed simply as a “network”.

The gNB 100 is a 5G-compliant radio base station and performs radio communication with the UE 200 according to 5G. The gNB 100 and the UE 200 can support Massive MIMO (Multiple-Input Multiple-Output) generating a beam BM with higher directivity by controlling radio signals transmitted from multiple antenna elements, carrier aggregation (CA) bundling and using multiple component carriers (CCs), and dual connectivity (DC) performing simultaneous communication with two or more transport blocks between the UE and each of the two NG-RAN Nodes.

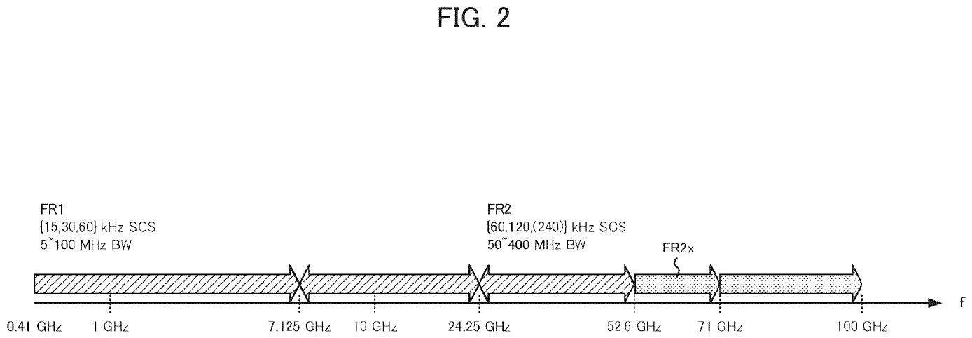

The radio communication system 10 supports multiple frequency ranges (FRs). FIG. 2 illustrates frequency ranges used in the radio communication system 10.

As illustrated in FIG. 2, the radio communication system 10 may support FR1, FR2-1, and FR2-2. Frequency bands of each FR are as follows.
FR1: 410 MHz to 7.125 GHZ
FR2-1: 24.25 GHz to 52.6 GHZ
FR2-2: 52.6 GHz to 71 GHZ

In FR1, a Sub-Carrier Spacing (SCS) of 15 , 30, or 60 kHz is used, and a bandwidth (BW) of 5 to 100 MHz may be used. FR2-1 is a higher frequency than FR1, an SCS of 60 or 120 kHz (240 KHz may be included) is used, and a bandwidth (BW) of 50 to 400 MHz may be used. FR2-2 is a higher frequency than FR2-1, an SCS of 120, 480 KHz, or 960 KHz is used, and a bandwidth (BW) of 400 to 2000 MHz may be used.

Note that the SCS may be interpreted as numerology.

Numerology is defined in 3 GPP TS38.300 and corresponds to one Sub-Carrier Spacing in a frequency domain.

The radio communication system 10 supports a frequency band higher than that of FR 2-2. Specifically, the radio communication system 10 supports a frequency band above 52.6 GHZ and up to 71 GHz or 114.25 GHz. Such a high frequency band may be called “FR2x” for convenience.

When a band above 52.6 GHz is used, Cyclic Prefix-Orthologous Frequency Division Multiplexing (CP-OFDM) or Discrete Fourier Transform-Spread (DFT-S-OFDM) having a larger SubCarrier Spacing (SCS) may be applied in response to an issue where the influence of phase noise increases in the high frequency band.

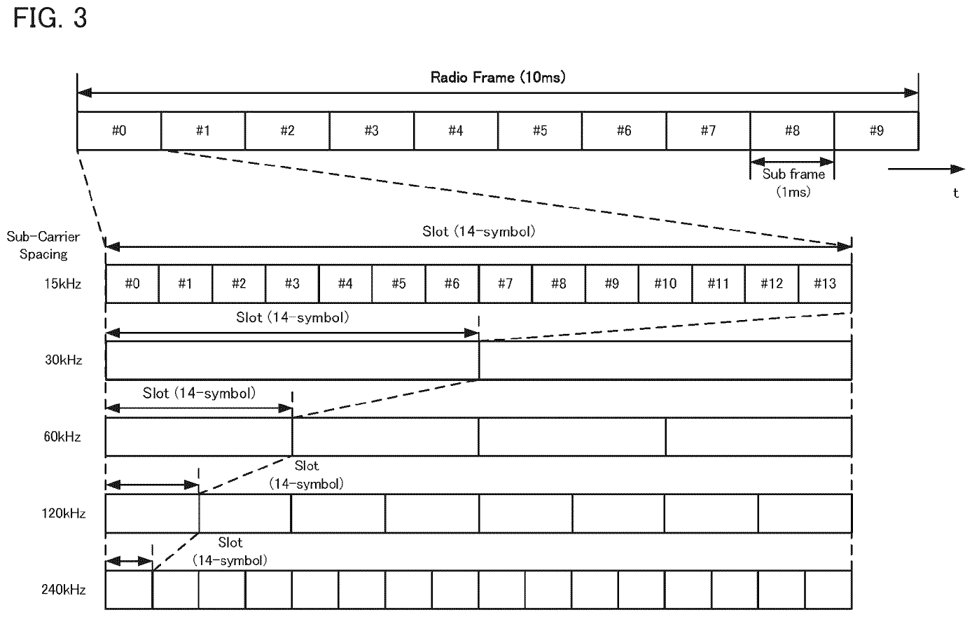

FIG. 3 illustrates a configuration example of a radio frame, subframes, and slots used in the radio communication system 10.

As illustrated in FIG. 3, a slot consists of 14 symbols, and the symbol length (and the slot length) gets shorter as the SCS gets larger (wider). The SCS is not limited to the spacing (frequencies) in FIG. 3. For example, 480 kHz, 960 kHz, or the like may be used.

The number of symbols constituting one slot does not necessarily have to be 14 (for example, it may be 28 or 56 symbols). Further, the number of slots per subframe may differ depending on the SCS.

Note that a time direction (t) in FIG. 3 may be called a time domain, a symbol length, a symbol time, or the like. A frequency direction may be called a frequency domain, a resource block, a subcarrier, a bandwidth part (BWP: Bandwidth Part), or the like.

A DMRS is a type of reference signal and is prepared for various channels. Here, unless otherwise noted, a DMRS for a downlink data channel, specifically for a PDSCH (Physical Downlink Shared Channel), may be understood. However, a DMRS for an uplink data channel, specifically for a PUSCH (Physical Uplink Shared Channel), may be interpreted in the same manner as a DMRS for a PDSCH.

The DMRS can be used for channel estimation in the UE 200 as a device, for example, part of coherent demodulation. The DMRS may be present only in a resource block (RB) used for a PDSCH transmission.

The DMRS may have multiple mapping types. Specifically, the DMRS has mapping type A and mapping type B. In mapping type A, the first DMRS is arranged on the second or third symbol of a slot. In mapping type A, the DMRS may be mapped based on slot boundaries regardless of where in the slot the actual data transmission begins. The reason why the first DMRS is arranged on the second or third symbol of the slot may be interpreted as to arrange the first DMRS after a control resource set (CORESET).

In mapping type B, the first DMRS may be arranged on the first symbol in data allocation. That is, the position of the DMRS may be provided relative to where data is arranged, not to slot boundaries.

The DMRS may have multiple types. Specifically, the DMRS may have Type 1 and Type 2. Type 1 and Type 2 differ in mapping in the frequency domain and the maximum number of orthogonal reference signals. Type 1 can output up to four orthogonal signals with a single-symbol DMRS, while Type 2 can output up to eight orthogonal signals with a double-symbol DMRS.

### (2) Functional Block Configuration of Radio Communication System

Next, a functional block configuration of the radio communication system 10 will be described.

First, a function block configuration of the UE 200 will be described.

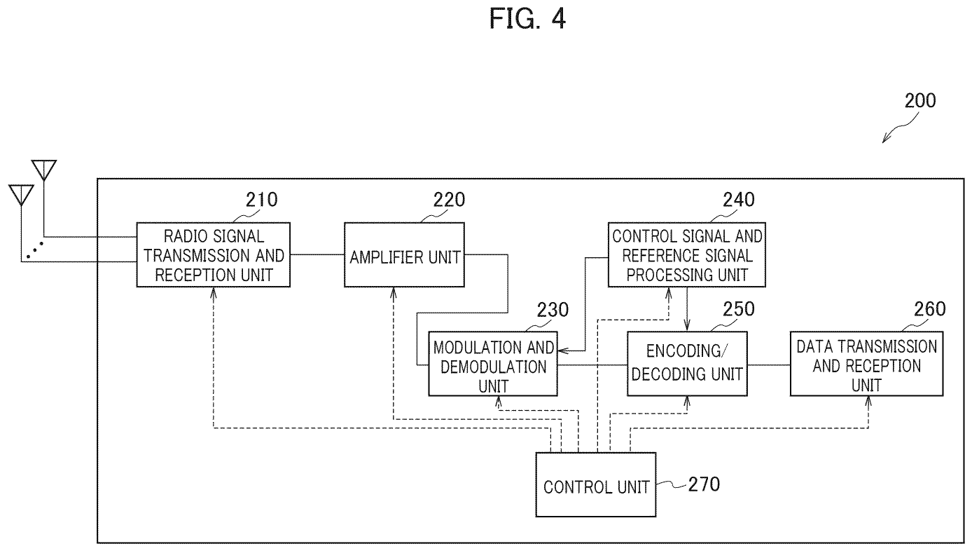

FIG. 4 is a functional block configuration diagram of the UE 200. As illustrated in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives radio signals according to NR. The radio signal transmission and reception unit 210 can support massive MIMO, carrier aggregation (CA) bundling and using multiple CCs, and DC performing simultaneous communication between a UE and each of two NG-RAN Nodes.

In the embodiment, the radio signal transmission and reception unit 210 includes a transmission unit that transmits predicted information on radio resource management (RRM) from the UE 200. The predicted information may be information predicted by the UE 200 using Artificial intelligence (AI) or Machine Learning (ML). The predicted information may be called AIML estimated value. The transmission of the predicted information may be read as a report of the predicted information. The predicted information may be included in a Measurement Report.

The amplifier unit 220 includes a PA (Power Amplifier)/ an LNA (Low Noise Amplifier), and the like. The amplifier unit 220 amplifies a signal output from the modulation and demodulation unit 230 to a predetermined power level. The amplifier unit 220 also amplifies an RF signal output from the radio signal transmission and reception unit 210.

The modulation and demodulation unit 230 performs data modulation/demodulation, transmission power configuration, resource block allocation, and the like for each predetermined communication destination (gNB 100 or another gNB). In the modulation and demodulation unit 230, Cyclic Prefix-Orthogonal Frequency Division Multiplexing (CP-OFDM) or Discrete Fourier Transform-Spread (DFT-S-OFDM) may be applied. DFT-S-OFDM may also be used for a downlink (DL) as well as an uplink (UL).

The control signal and reference signal processing unit 240 performs processing regarding various control signals transmitted and received by the UE 200, and processing regarding various reference signals transmitted and received by the UE 200.

Specifically, the control signal and reference signal processing unit 240 receives various control signals transmitted from the gNB 100 via a predetermined control channel, for example, a control signal of a radio resource control (RRC) layer. The control signal and reference signal processing unit 240 also transmits various control signals to the gNB 100 via a predetermined control channel.

The control signal and reference signal processing unit 240 performs processing using a reference signal (RS), such as a Demodulation Reference Signal (DMRS) and a Phase Tracking Reference Signal (PTRS).

The DMRS is a reference signal (pilot signal) specific to a terminal, known between a base station and a terminal for estimating a fading channel used for data demodulation. The PTRS is a reference signal specific to the UE 200 for the purpose of estimating phase noise, which becomes an issue in a high frequency band.

Note that the reference signal may include a Channel State Information-Reference Signal (CSI-RS), a Sounding Reference Signal (SRS), and a Positioning Reference Signal (PRS) for positional information, in addition to the DMRS and the PTRS.

The channel includes a control channel and a data channel. The control channel includes a PDCCH (Physical Downlink Control Channel), a PUCCH (Physical Uplink Control Channel), an RACH (Random Access Channel), Downlink Control Information (DCI) including a Random Access Radio Network Temporary Identifier (RA-RNTI), a Physical Broadcast Channel (PBCH), and the like.

The data channel includes a PDSCH (Physical Downlink Shared Channel), a PUSCH (Physical Uplink Shared Channel), and the like. Data here means data that is transmitted via a data channel. The data channel may be substituted with a shared channel.

Here, the control signal and reference signal processing unit 240 may receive Downlink Control Information (DCI). The DCI includes existing fields to store DCI formats, a carrier indicator (CI), a BWP indicator, an FDRA (Frequency Domain Resource Allocation), a TDRA (Time Domain Resource Allocation), an MCS (Modulation and Coding Scheme), an HPN (HARQ Process Number), an NDI (New Data Indicator), an RV (Redundancy Version), and the like.

A value stored in a DCI Format field is an information element to specify a format of the DCI. A value stored in a CI field is an information element to specify a CC to which the DCI is applied. A value stored in a BWP indicator field is an information element to specify a BWP to which the DCI is applied. The BWP, which can be specified by the BWP indicator, is configured using an information element (Bandwidtpart-Config) included in an RRC message. A value stored in an FDRA field is an information element to specify a frequency domain resource to which the DCI is applied. The frequency domain resource is identified by a value stored in the FDRA field and an information element (RA Type) included in the RRC message. A value stored in a TDRA field is an information element to specify a time domain resource to which the DCI is applied. The time domain resource is identified by a value stored in the TDRA field and an information element (pdsch-TimeDomainAllocationList, pusch-TimeDomainAllocationList) included in the RRC message. The time domain resource may be identified by a value stored in the TDRA field and a default table. A value stored in an MCS field is an information element to specify an MCS to which the DCI is applied. The MCS is identified by a value stored in the MCS, and an MCS table. The MCS table may be specified by the RRC message, or identified by RNTI scrambling. A value stored in an HPN field is an information element to specify an HARQ Process to which the DCI is applied. A value stored in the NDI is an information element to identify whether data, to which the DCI is applied, is the first transmission data. A value stored in an RV field is an information element to specify the redundancy of data to which the DCI is applied.

The encoding/decoding unit 250 performs data division/concatination, channel coding/decoding, and the like for each predetermined communication destination (gNB 100 or another gNB).

Specifically, the encoding/decoding unit 250 divides the data output from the data transmission and reception unit 260 into predetermined sizes and performs channel coding on the divided data. The encoding/decoding unit 250 also decodes the data output from the modulation and demodulation unit 230 and connects the decoded data.

The data transmission and reception unit 260 performs transmission and reception for protocol data units (PDU) and service data units (SDU). Specifically, the data transmission and reception unit 260 performs assembly, disassembly, and the like for PDUs/SDUs in multiple layers (medium access control (MAC) layer, radio link control (RLC) layer, packet data convergence protocol (PDCP) layer, and the like). The data transmission and reception unit 260 also performs error correction and retransmission control of data, based on an HARQ (Hybrid Automatic Repeat Request).

The control unit 270 controls each of the functional blocks configuring the UE 200. In the embodiment, the control unit 270 identifies predicted information on radio resource management (RRM) of the UE 200. The control unit 270 may identify predicted information using AI or ML. The identification of predicted information may be read as estimation of predicted information. The following options may be considered as predicted information.

In option 1-1, predicted information may include predicted information on cell quality. The cell quality may include at least one of an RSRP (Reference Signal Received Power), an RSRQ (Reference Signal Received), or an SINR (Signal to Interference Noise Ratio) of a serving cell. The cell quality may include at least one of an RSRP, an RSRQ, or an SINR of a neighboring cell. The predicted information on the cell quality may be called Predicted cell radio quality. The predicted information on the cell quality may include time information. For example, the predicted information on the cell quality may include an RSRP of cell A at time X and an RSRP of cell A at time Y. Time X and time Y are future times. The predicted information on the cell quality may be used in a Handover (including NG handover), in a DC (Dual Connectivity), or in a case where the gNB 100 is separated into a CU (Central Unit) and a DU (Distributed Unit).

In option 1-2, the predicted information may include predicted information on beam quality. The beam quality may include at least one of an RSRP, an RSRQ, or an SINR of a serving beam (for example, SSB (Synchronization Signal Block), CSI-RS (Channel State Information Reference Signal), or the like). The beam quality may include at least one of an RSRP, an RSRQ, and an SINR of an adjacent beam (for example, SSB, CSI-RS, or the like) . The predicted information on the beam quality may be called Predicted beam radio quality. The predicted information on the beam quality may include time information. For example, the predicted information on the cell quality may include an RSRP of SSB #1 at time X and an RSRP of SSB #2 at time Y. Time X and time Y are future times. The predicted information on the beam quality may be used in a Handover (including NG Handover), in a DC, or in a case where the gNB 100 is separated into a CU and a DU.

In option 1-3, the predicted information may include predicted information on a terminal trajectory. The terminal trajectory may be represented by the location of the UE 200. The location of the UE 200 may be represented by latitude and longitude. The predicted information on the terminal trajectory may be called Predicted UE trajectory. The predicted information on the terminal trajectory may include time information. For example, the predicted information on the terminal trajectory may include location #1 at time X, and location #2 at time Y. Time X and time Y are future times. The predicted information on the terminal trajectory may be used in a handover (including NG handover), in a DC, or in a case where the gNB 100 is divided into a CU and a DU.

Here, when the UE 200 is a UAV (Unmanned/Uncrewed Aerial Vehicle), such as a drone, the location of the UE 200 may be represented by altitude. The predicted information on the terminal trajectory may include time information. For example, the predicted information on the terminal trajectory may include Hight #1 at time X, and Hight #2 at time Y. Time X and time Y are future times.

In option 1-4, the predicted information may include predicted information on a future cell trajectory. The future cell trajectory may be represented by an ID of a cell (Cell ID). The predicted information on the future cell trajectory may be called Predicted future cell trajectory. The predicted information on the future cell trajectory may include time information. For example, the predicted information on the future cell trajectory may include a cell A at time X, and a cell B at time Y. Time X and time Y are future times. The predicted information on the future cell trajectory may be used in a Handover (including NG Handover), in a DC, or in a case where the gNB 100 is separated into a CU and a DU.

In option 1-5, the predicted information may include predicted information on a target cell. The target cell may be represented by an ID of a cell (Cell ID). The predicted information on the target cell may be called Predicted target cell(s) or Preferred target cell(s). The predicted information on the target cell may be used in a Handover (including NG Handover), in a DC, or in a case where the gNB 100 is separated into a CU and a DU.

In option 1-6, predicted information may include predicted information on a target beam. The target beam may be represented by an SSB index(es), a CSI-RS index(es), a TCI (Transmission Configuration Indicator) state, or a BWP. The predicted information on the target beam may be called Predicted target beam(s) or Preferred target beam(s). The predicted information on the target beam may be used in a Handover (including NG Handover), in a DC, or in a case where the gNB 100 is separated into a CU and a DU.

In option 1-7, the predicted information may include predicted information on a candidate target cell. The candidate target cell may be represented by an ID of a cell (Cell ID). The predicted information on the candidate target cell may be called Predicted candidate target cell(s) or Suggested candidate target cell(s). The predicted information on the candidate target cell may be used in a CHO (Conditional Handover) or in an LTM (Lower Layer triggered Mobility).

In option 1-8, the predicted information may include predicted information on activation or deactivation of a candidate target cell. The candidate target cell may be represented by an ID of a cell (Cell ID). The predicted information on activation or deactivation of the candidate target cell may be called Predicted activation/deactivation status of candidate target cell(s), or Suggested activation/deactivation status of candidate target cell(s). The predicted information on activation or deactivation of the candidate target cell may be used in a CHO or in an LTM.

In option 1-9, the predicted information may include predicted information on an antenna direction. The antenna direction may be represented by an Antenna boresight direction. The predicted information on the antenna direction may be called Predicted antenna direction. The predicted information on the antenna direction may be used to switch beams within a cell.

In option 1-10, the predicted information may include predicted information on a beam direction. The beam direction may be represented by an Antenna boresight direction. The predicted information on the beam direction may be called Predicted beam direction. The predicted information on the beam direction may be used to switch beams within a cell.

In option 1-11, the predicted information may include predicted information on a measurement target beam. The measurement target beam may be represented by an SSBToMeasure List. The predicted information on the measurement target beam may be called Predicted beams to measure. The predicted information on the measurement target beam may be used to configure an SSB.

In option 1-12, the predicted information may include predicted information on a measurement gap length. The measurement gap length may be represented by absolute time (ms), or the number of symbols. The predicted information on the measurement gap length may be called Predicted measurement gap length. The predicted information on the measurement gap length may be used to configure a measurement gap length.

In option 1-13, the predicted information may include predicted information on a measurement gap period. The measurement gap period may be represented by an absolute time (ms), or the number of symbols. The predicted information on the measurement gap period may be called Predicted measurement gap periodicity. The predicted information on the measurement gap period may be used to configure a measurement gap periodicity.

Two or more options selected from the options 1-1 to 1-13 described above may be combined.

Here, the control unit 270 may instruct the radio signal transmission and reception unit 210 to transmit (report) the predicted information according to the following options.

In option 2-1, the predicted information may be transmitted periodically at a specific period. The specific period may be configured or specified by the gNB 100. The specific period may be configured by an RRC, specified by a MAC CE or a DCI, or predefined in the radio communication system 10.

In option 2-2, the predicted information may be transmitted in response to a request from the gNB 100. The request from the gNB 100 may be an RRC, a MAC CE, or a DCI.

In option 2-3, the predicted information may be transmitted in response to a specific event. The specific event may include the following options.

In option 2-3-1, the specific event may be that a quality estimated value of a Serving cell (for example, RSRP, RSRQ, or SINR) is greater than a predetermined threshold. The predetermined threshold may be configured by an RRC, specified by a MAC CE or DCI, or predefined in the radio communication system 10.

In option 2-3-2, the specific event may be that a quality estimated value of a Serving cell (for example, RSRP, RSRQ, or SINR) is less than a predetermined threshold. The predetermined threshold may be configured by an RRC, specified by a MAC CE or DCI, or predefined in the radio communication system 10.

In option 2-3-3, the specific event may be that a quality estimated value of a Neighbor cell (for example, RSRP, RSRQ, or SINR) is greater than a predetermined threshold. The predetermined threshold may be configured by an RRC, specified by a MAC CE or DCI, or predefined in the radio communication system 10.

In option 2-3-4, the specific event may be that a quality estimated value of a Neighbor cell (for example, RSRP, RSRQ, or SINR) is less than a predetermined threshold. The predetermined threshold may be configured by an RRC, specified by a MAC CE or DCI, or predefined in the radio communication system 10.

In option 2-3-5, the specific event may be that a quality estimated value of a Neighbor cell (for example, RSRP, RSRQ, or SINR) is greater than or equal to an SpCell by a predetermined offset. The predetermined offset may be configured by an RRC, specified by a MAC CE or DCI, or predefined in the radio communication system 10.

In option 2-3-6, the specific event may be that a quality estimated value of a Neighbor cell (for example, RSRP, RSRQ, or SINR) is greater than or equal to the quality estimated value of a SpCell by a predetermined offset. The predetermined offset may be configured by an RRC, specified by a MAC CE or DCI, or predefined in the radio communication System 10.

In option 2-3-7, the specific event may be that a quality estimated value of an SpCell (for example, RSRP, RSRQ, or SINR) is less than a predetermined threshold 1, and a quality estimated value of a Neighbor cell (for example, RSRP, RSRQ, or SINR) is greater than a predetermined threshold 2. The predetermined threshold 1 and the predetermined threshold 2 may be configured by an RRC, specified by a MAC CE or DCI, or predefined in the radio communication system 10.

In option 2-3-8, the specific event may be that a quality estimated value of a Neighbor cell (for example, RSRP, RSRQ, or SINR) is greater than or equal to an SCell quality observed value or SCell quality estimated value by a predetermined offset. The predetermined offset may be configured by an RRC, specified by a MAC CE or DCI, or predefined in the radio communication system 10.

In option 2-3-9, the specific event may be that an estimated value of an Inter RAT neighbor cell (for example, RSRP, RSRQ, or SINR) is greater than a predetermined threshold. The predetermined threshold may be configured by an RRC, specified by a MAC CE or DCI, or predefined in the radio communication system 10.

In option 2-3-10, the specific event may be that a PCell estimated value (for example, RSRP, RSRQ, or SINR) is less than the predetermined threshold 1, and an estimated value of an inter RAT neighbor cell (for example, RSRP, RSRQ, or SINR) is greater than the predetermined threshold 2. The predetermined threshold 1 and predetermined threshold 2 may be configured by an RRC, specified by a MAC CE or DCI, or predefined in the radio communication system 10.

Two or more options selected from the options 2-3-1 to option 2-3-10 may be combined. A specific event to be applied to the UE 200 may be configured by an RRC or specified by a MAC CE or DCI.

Second, a functional block configuration of the gNB 100 will be described.

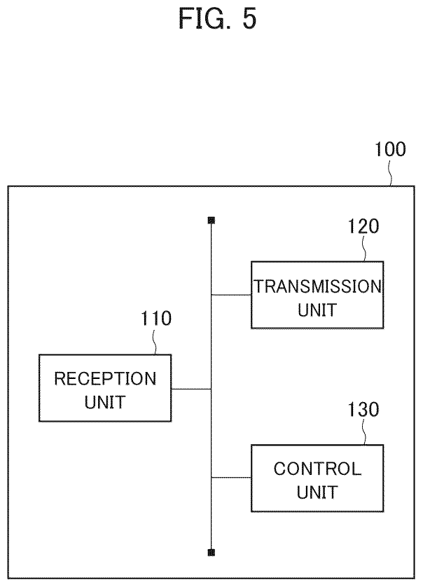

FIG. 5 is a functional block configuration diagram of the gNB 100. As illustrated in FIG. 5, the gNB 100 includes a reception unit 110, a transmission unit 120, and a control unit 130.

The reception unit 110 receives various signals from UEs 200. The reception unit 110 may receive UL signals via a PUCCH or PUSCH. In the embodiment, the reception unit 110 constitutes a reception unit that receives predicted information on RRM from the UE 200.

The transmission unit 120 transmits various signals to UEs 200. The transmission unit 120 may transmit DL signals via a PDCCH or PDSCH.

The control unit 130 controls the gNB 100. In the embodiment, the control unit 130 constitutes a control unit that assumes that the UE 200 identifies predicted information on RRM of the UE 200.

### (3) AIML Model

An AIML (Artificial Intelligence Machine Learning) model will be described below. The AIML model is used to identify (estimate) predicted information described above.

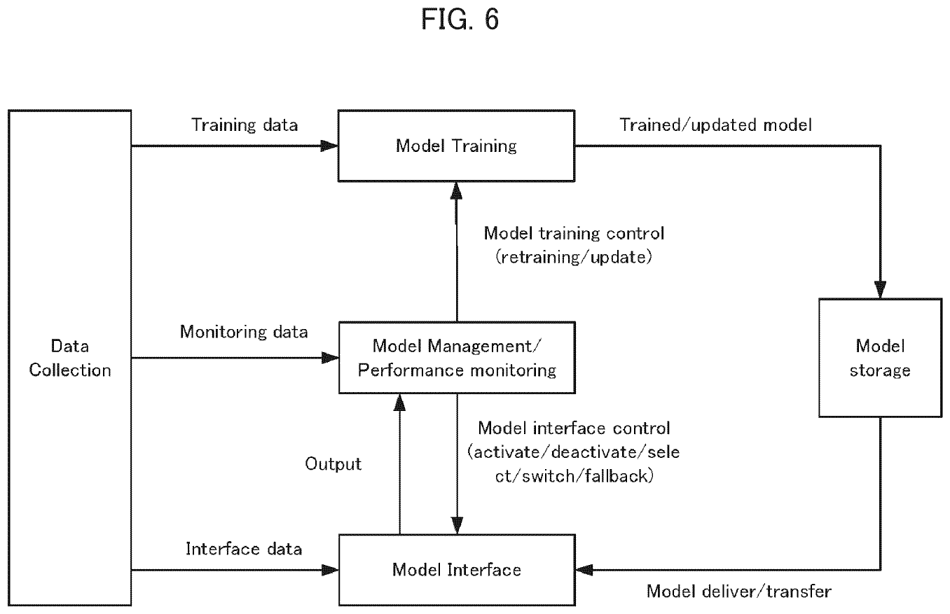

As illustrated in FIG. 6, the AIML model may include functions such as Data collection, Model training, Model Interface, Model Management/Performance monitoring, and Model storage.

Data collection collects input data of a model used to identify (estimate) predicted information. Data collection outputs the input data (Training Data) to Model training.

Data collection outputs input data (Monitoring Data) to Model Management/Performance monitoring. Data collection outputs input data (Interface Data) to Model Interface.

Based on the Training Data, Model training performs training, validation, and testing of a model used to identify (estimate) predicted information. Model training may perform pre-processing, such as cleaning, formatting, and conversion of the Training Data. Model training outputs a trained or updated model to Model storage.

Model Interface outputs predicted information (Output) corresponding to input data (Interface Data) using a model acquired from Model storage. Model Interface may output predicted information (Output) as feedback to Model Management/Performance monitoring.

Model Management/Performance monitoring outputs, to Model Interface, information (Model Interface Control) used to identify a model to be used by Model Interface. Identification may be called activation, deactivation, selection, switching, fallback, or the like. Model Management/Performance monitoring outputs, to Model training, information (Model training control) used to retrain or update a model, based on input data (Monitoring Data) and predicted information (Output).

Model storage stores a model output from Model training. Model storage outputs the stored model to Model Interface. The output of the model may be called Model deliver/transfer.

Under such a background, Data collection and Model Interface may be provided at least in the UE 200. Model training, Model Management/Performance monitoring, and Model storage may be provided in the UE 200, gNB 100, a core network node, an OAM (Operation and Management) node, a 3GPP-compliant server, or a non-3GPP-compliant server.

### (4) Operation Examples

Operation examples will be described below. As operation examples, the following variations are considered.

### (4.1) Operation Example 1

In operation example 1, a handover from a Source gNB to a Target gNB will be described.

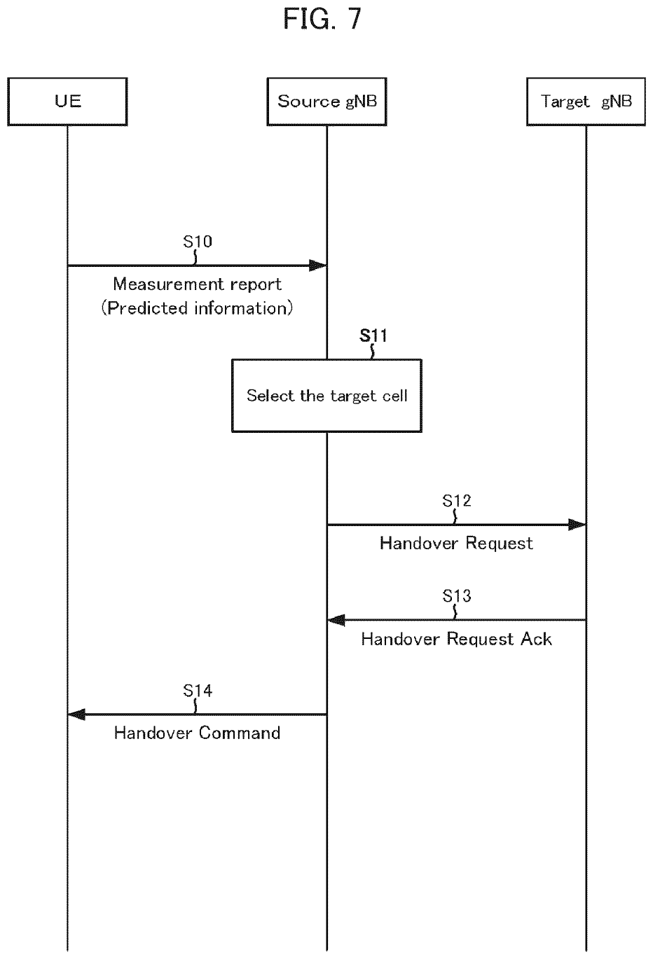

As illustrated in FIG. 7, in step S10, the UE 200 transmits a Measurement report to the Source gNB. The Measurement report includes predicted information (AIML estimated value). The AIML estimated value may include a Predicted cell radio quality, a Predicted beam radio quality, a Predicted UE trajectory, a Predicted future cell trajectory, a Predicted target cell(s), a Predicted target beam(s), or the like.

In step S11, the Source gNB selects a target cell, based on predicted information included in the Measurement report. The Source gNB may select a target cell, based on a measurement result included in the Measurement report, in addition to the predicted information included in the Measurement report.

In step S12, the Source gNB transmits a Handover Request to the Target gNB. Here, a case where the target cell belongs to the Target gNB will be described.

In step S13, the Target gNB transmits a Handover Request Ack to the Source gNB.

In step S14, the Source gNB transmits, to the UE 200, a Handover Command indicating a handover from the Source gNB to the Target gNB.

### (4.2) Operation Example 2

In operation example 2, a CHO from a Source qNB to a Candidate target gNB(s) will be described.

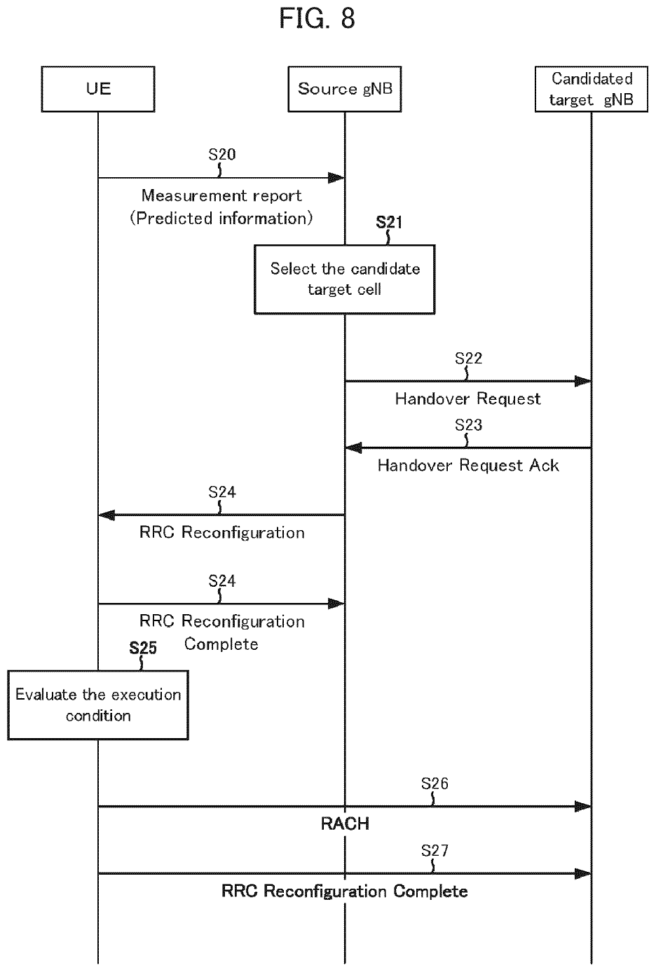

As illustrated in FIG. 8, in step S20, the UE 200 transmits a Measurement report to the Source gNB. The Measurement report includes predicted information (AIML estimated value). The AIML estimated value may include a Predicted candidate target cell(s), a Predicted activation/deactivation status of candidate target cell(s), or the like.

In step S21, the Source gNB selects a candidate target cell, based on predicted information included in the Measurement report. The Source gNB may select a candidate target cell, based on a measurement result included in the Measurement report, in addition to the predicted information included in the Measurement report.

In step S22, the Source gNB transmits a Handover Request to a Target gNB. Here, a case where the candidate target cell belongs to the Target gNB will be described.

In step S23, the Target gNB transmits a Handover Request Ack to the Source gNB.

In step S24, the Source gNB transmits an RRCReconfiguration to the UE 200.

In step S25, the UE 200 transmits an RRCReconfigurationComplete to the Source gNB.

In step S26, the UE 200 evaluates a performance condition of a CHO.

In step S27, the UE 200 transmits an RACH to the Candidate target gNB(s).

In step S28, the UE 200 transmits an RRCReconfigurationComplete to the Candidate target gNB(s).

### (4.3) Operation Example 3

In operation example 3, an LTM will be described.

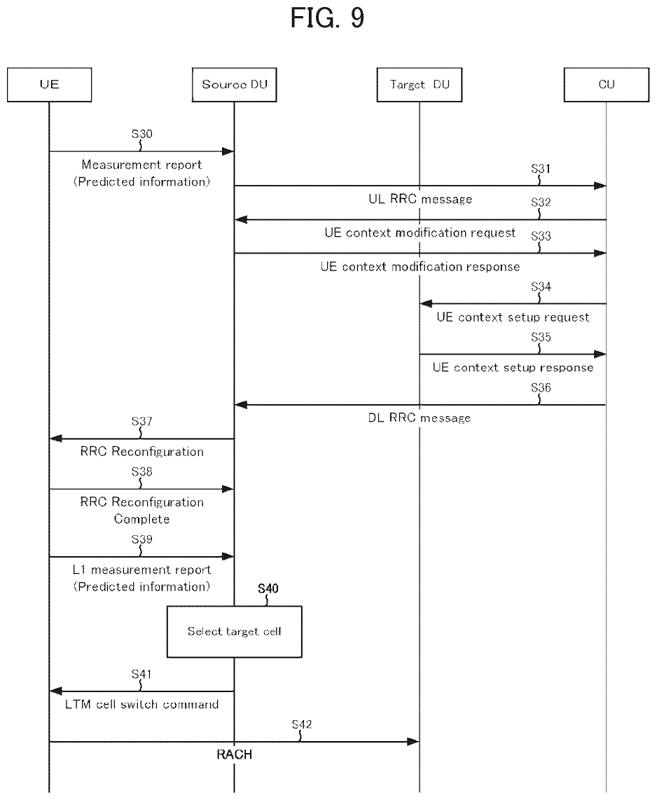

As illustrated in FIG. 9, in step S30, the UE 200 transmits a Measurement report to a CU via a Source DU. The Measurement report includes predicted information (AIML estimated value). The AIML estimated value may include a Predicted candidate target cell(s), a Predicted activation/deactivation status of a candidate target cell(s), or the like.

In step S31, the Source DU transmits a UL RRC message to the CU. The Source DU may transmit (forward) the predicted information (AIML estimated value) included in the Measurement report.

In step S32, the CU transmits a UE context modification request to the Source DU.

In step S33, the Source DU transmits a UE context modification response to the CU.

In step S34, the CU transmits a UE context setup request to the Target DU.

In step S35, the Target DU transmits a UE context setup response to the CU.

In step S36, the CU transmits a DL RRC message to the Source DU.

In step S37, the Source DU transmits an RRCReconfiguration to the UE 200.

In step S38, the UE 200 transmits an RRCReconfigurationComplete to the Source DU.

In step S39, the UE 200 transmits an L1 measurement report to the Source DU. The L1 measurement report includes predicted information (AIML estimated value). The AIML estimated value may include a Predicted cell radio quality, a Predicted beam radio quality, a Predicted UE trajectory, a Predicted future cell trajectory, a Predicted target cell(s), a Predicted target beam(s), or the like.

In step S40, the Source DU selects a target cell, based on the predicted information included in the Measurement report. The Source gNB may select the target cell, based on a measurement result included in the Measurement report, in addition to the predicted information included in the Measurement report.

In step S41, the Source DU transmits an LTM cell switch command to the UE 200.

In step S42, the UE 200 transmits an RACH to the Target DU.

### (4.4) Operation Example 4

In operation example 4, a case where a Target gNB 1 selects a future target cell in a handover from a Source gNB to the Target gNB1 will be described.

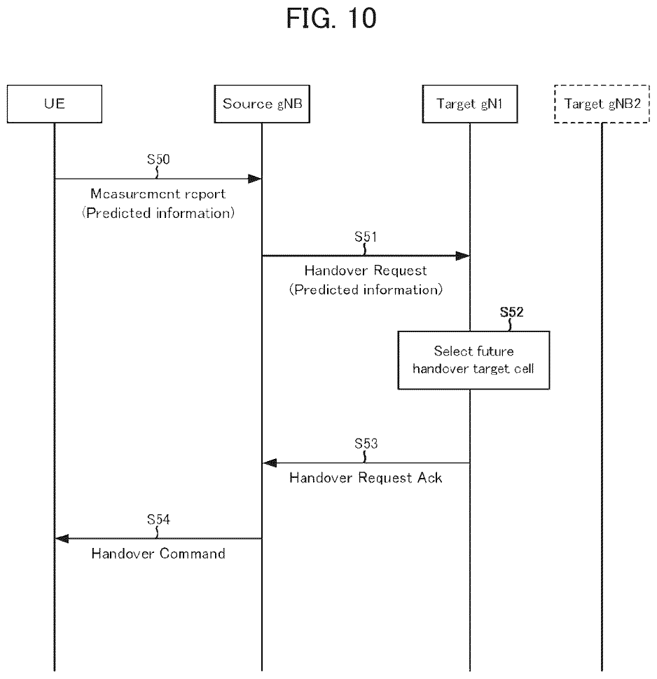

As illustrated in FIG. 10, in step S50, the UE 200 transmits a Measurement report to the Source gNB. The Measurement report includes predicted information (AIML estimated value). The AIML estimated value may include a Predicted cell radio quality, a Predicted beam radio quality, a Predicted UE trajectory, a Predicted future cell trajectory, a Predicted target cell(s), a Predicted target beam(s), or the like.

In step S51, the Source gNB transmits a Handover Request to the Target gNB1. The Handover Request may include the predicted information (AIML estimated value) included in the Measurement report.

In step S52, the Target gNB1 selects a future target cell (in FIG. 10, Target NB2), based on the predicted information included in the Handover Request.

In step S53, the Target gNB1 transmits a Handover Request Ack to the Source gNB.

In step S54, the Source gNB transmits to the UE 200 a Handover Command instructing a handover from the Source gNB to the Target gNB1.

According to operation example 4, the Target gNB 1 selects a future target cell in advance, based on the predicted information (AIML estimated value) included in the Handover Request. With this configuration, assuming a case where the Target gNB1 becomes the Source gNB (that is, the next Handover of the Handover illustrated in FIG. 10), even when it takes time for the UE 200 to output predicted information (AIML estimated value), the Target qNB1 can appropriately select a future target cell without obtaining the predicted information (AIML estimated value) again from the UE 200. By omitting the operation of transmitting the predicted information (AIML estimated value) again from the UE 200 to the Target gNB1, unnecessary signaling can be expected to be reduced.

### (4.5) Operation Example 5

Operation example 5 describes an NG handover from a Source gNB to a Target gNB.

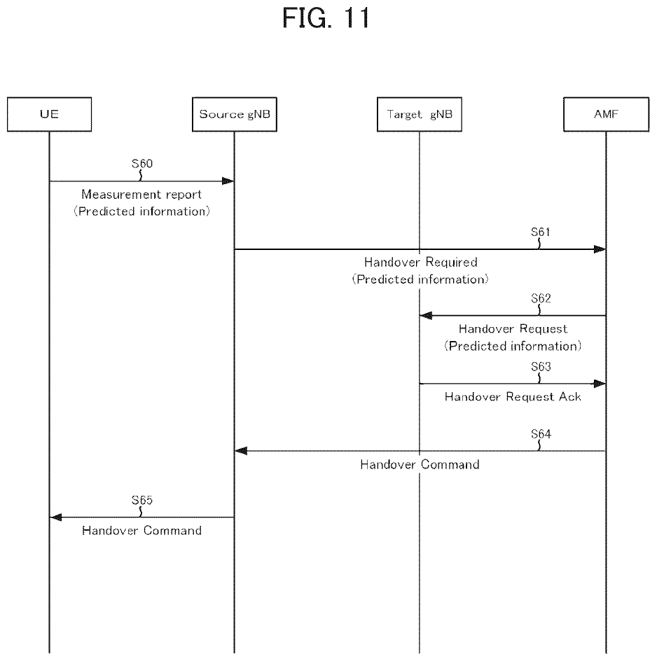

As illustrated in FIG. 11, in step S60, the UE 200 transmits a Measurement report to the Source gNB. The Measurement report includes predicted information (AIML estimated value). The AIML estimated value may include a Predicted cell radio quality, a Predicted beam radio quality, a Predicted UE trajectory, a Predicted future cell trajectory, a Predicted target cell(s), a Predicted target beam(s), or the like.

In step S61, the Source gNB transmits a Handover Required to an AMF (Access and Mobility Management Function). The Handover Required may include the predicted information (AIML estimated value) included in the Measurement report.

In step S62, the AMF transmits a Handover Request to the Target gNB. The Handover Request may include the predicted information (AIML estimated value) included in the Handover Required.

In step S63, the Target gNB transmits a Handover Request Ack to the AMF.

In step S64, the AMF transmits a Handover Command to the Source gNB.

In step S65, the Source qNB transmits, to the UE 200, a Handover Command indicating a handover from the Source gNB to the Target gNB.

According to operation example 5, the Source gNB transmits predicted information (AIML estimated value) to the Target gNB via the AMF. With this configuration, assuming a case where the Target gNB becomes the Source gNB (that is, the next Handover of the Handover illustrated in FIG. 11), even when it takes time for the UE 200 to output the predicted information (AIML estimated value), the Target gNB can appropriately select a target cell, based on the predicted information (AIML estimated value) previously acquired via the AMF without acquiring the predicted information (AIML estimated value) again from the UE 200. By omitting the operation of transmitting the predicted information (AIML estimated value) again from the UE 200 to the Target gNB, unnecessary signaling can be expected to be reduced.

### (4.6) Operation Example 6

In operation example 6, communication between an MN (Master Node) and an SN (Secondary Node) will be described.

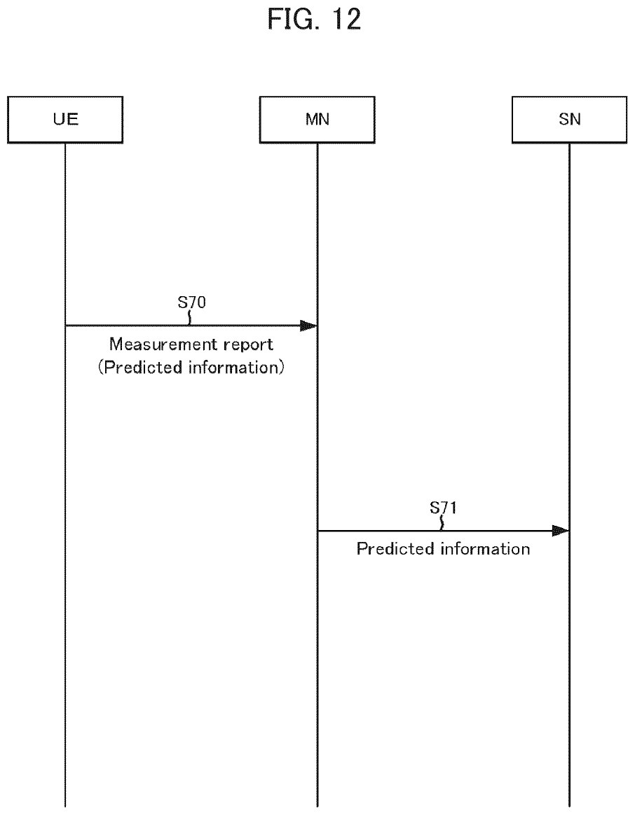

As illustrated in FIG. 12, in step S70, the UE 200 transmits a Measurement report to the MN. The measurement report includes predicted information (AIML estimated value). The AIMAL estimated value may include a Predicted cell radio quality, a Predicted beam radio quality, a Predicted UE trajectory, a Predicted future cell trajectory, a Predicted target cell(s), a Predicted target beam(s), or the like.

In step S71, the MN transmits the predicted information (AIML estimated value) included in the Measurement report to the SN. The MN may transmit part of the predicted information (AIML estimated value) included in the Measurement report to the SN.

According to operation example 6, the MN transmits predicted information (AIML estimated value) to the SN. With this configuration, assuming a case where the predicted information (AIML estimated value) includes information on a cell of the SN, such as a PSCell, the SN can appropriately perform processing (for example, selecting a target cell in the SN) related to mobility in the SN, based on the predicted information (AIML estimated value) acquired from the MN.

### (4.7) Operation Example 7

In operation example 7, a case where a gNB is separated into a DU and a CU will be described.

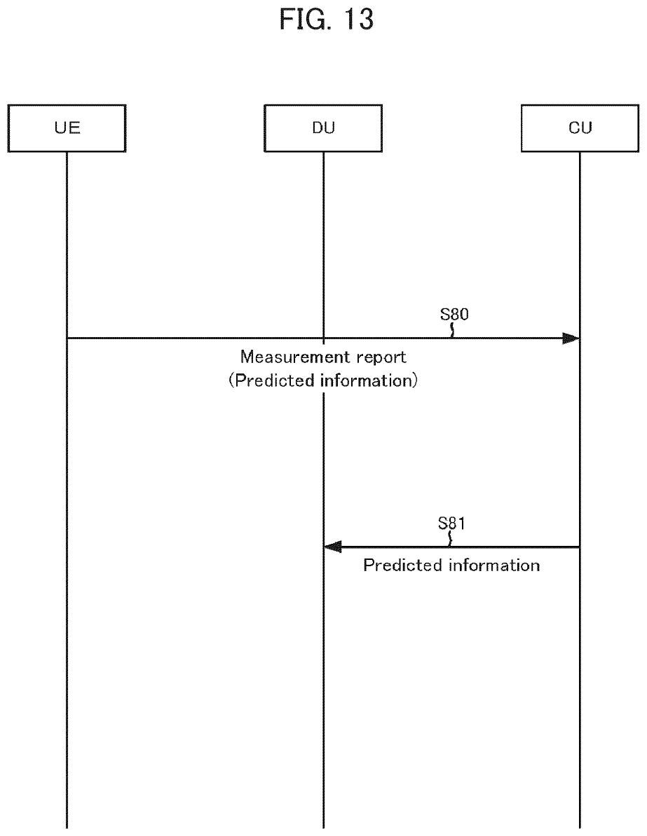

As illustrated in FIG. 13, in step S80, the UE 200 transmits a Measurement report to the CU. The measurement report includes predicted information (AIML estimated value). The AIML estimated value may include a Predicted cell radio quality, a Predicted beam radio quality, a Predicted UE trajectory, a Predicted future cell trajectory, a Predicted target cell(s), a Predicted target beam(s), or the like.

In step S81, the CU transmits the predicted information (AIML estimated value) included in the Measurement report to the DU. The CU may transmit part of the predicted information (AIML estimated value) included in the Measurement report to the DU.

According to operation example 7, the CU transmits the predicted information (AIML estimated value) to the DU. With this configuration, the DU can appropriately perform processing (for example, selecting a target cell in the DU) related to mobility within the DU, based on the predicted information (AIML estimated value) acquired from the CU.

### (5) Operation and Effect

In the embodiment, the UE 200 identifies predicted information (AIML estimated value) related to RRM of the UE 200, and transmits (reports) the identified predicted information. With this configuration, the RRM can be optimized using predicted information based on AI or ML. Specifically, the RRM can be optimized by defining the content of the predicted information, and the RRM can be optimized by defining a trigger for transmitting the predicted information.

### (6) Other Embodiments

Although the contents of the present invention have been described above along the embodiment, the present invention is not limited to these descriptions, and it is obvious to those skilled in the art that various modifications and improvements are possible.

As described in the above disclosure, the predicted information (AIML estimated value) may be reported to the gNB 100 in a manner included in a conventional L3 measurement report, or may be reported to the gNB 100 in a manner included in an L1 measurement report. However, the above disclosure is not limited to these. For example, the predicted information (AIML estimated value) may be reported to the gNB 100 using a newly defined RRC message, a MAC CE, or a PUCCH.

Although not specifically mentioned in the above disclosure, a UE capability may be defined that includes information explicitly or implicitly indicating an option supported by the UE 200 from among the options 1-1 to 1-13 described above. A UE capability may be defined that includes information explicitly or implicitly indicating an option supported by the UE 200 from among the options 2-1 to 2-3 described above. The UE capability may be reported from the UE 200 to the gNB 100.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

The block diagram (FIGS. 4 and 5) used in the description of the above-described embodiment illustrates blocks in units of functions. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

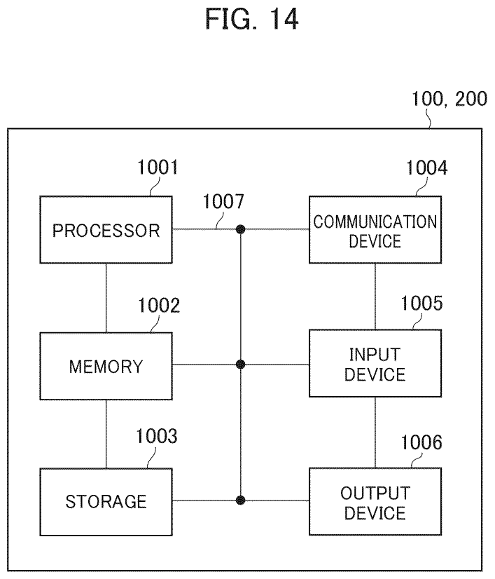

Further, the above-described gNB 100 and UE 200 (the devices) may function as a computer that performs processing of a radio communication method of the present disclosure. FIG. 14 is a diagram illustrating an example of a hardware configuration of the device. As illustrated in FIG. 14, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the device (FIGS. 4 and 5) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 controls the whole computer by, for example, running an operating system. The processor 1001 may be configured with a0 central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus) ” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on.

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the device may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI) ), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (LTE), LTE-Advanced (LTE-A), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal) ), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark) ), IEEE 802.16 (WiMAX (registered trademark) ), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these. According to the above, a case is described in which there is a single network node other than the base station 10. However, a combination of multiple other network nodes may be considered (e.g., MME and S-GW).

Information or signals (information and the like) may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any of a one of various different technologies. For example, data, an instruction, a command, information, a signal, a bit, a symbol, a chip, or the like, described throughout the present application, may be represented by a voltage, an electric current, electromagnetic waves, magnetic fields, magnetic particle, optical fields, a photon, or a combination thereof.

It should be noted that a term used in the present specification and/or term required for understanding of the present specification may be replaced by a term having the same or similar meaning. For example, a channel and a symbol may be a signal (signaling). Further a signal may also be a message. Further, the component carrier (CC) may be referred to as a carrier frequency, cell, frequency carrier, or the like.

As used in the present disclosure, the terms “system” and “network” are used interchangeably.

Furthermore, the information, parameters, and the like, described in the present disclosure may be expressed using absolute values, relative values from a predetermined values, or they may be expressed using corresponding different information. For example, a radio resource may be what is indicated by an index.

The names used for the parameters described above are not used as limitation. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells (also called sectors). When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a mobile station (hereinafter, a user terminal). For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, mobile stations may have the functions of the base stations described above. The words such as “uplink” and “downlink” may be interpreted as the words corresponding to the terminal-to-terminal communication (for example, “side”). For example, an uplink channel, a downlink channel and so on may be interpreted as a sidelink channel.

Likewise, the mobile station in the present disclosure may be interpreted as base station. In this case, the base station may have the functions of the mobile station described above.

A radio frame may be constituted of one or a plurality of periods (frames) in the time domain. Each of one or a plurality of periods (frames) constituting a radio frame may be referred to as a “subframe.”

Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

In the case where the terms “include”, “including” and variations thereof are used in the present disclosure, these terms are intended to be comprehensive in the same way as the term “comprising”. Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

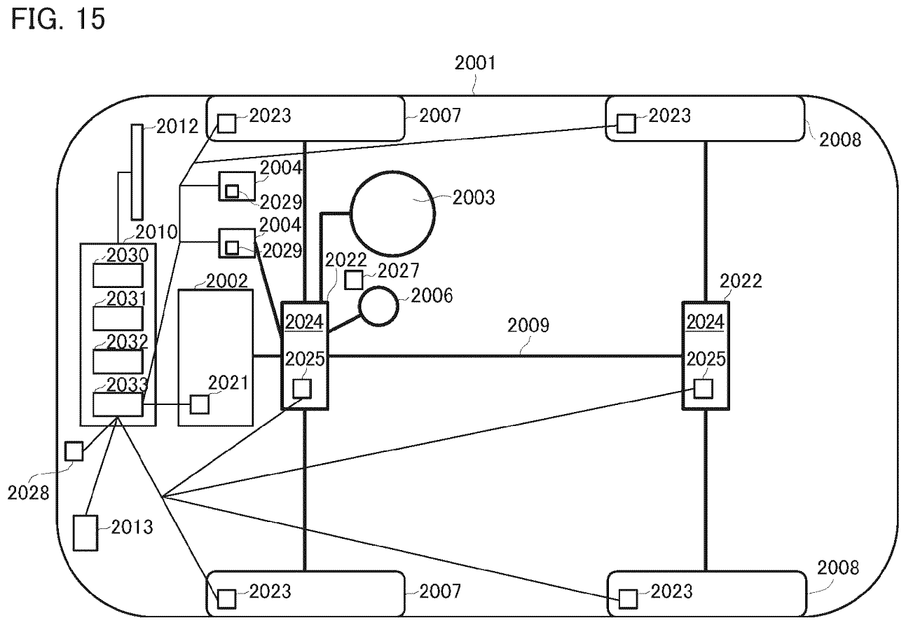

FIG. 15 shows a configuration example of a vehicle 2001. As shown in FIG. 15, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (10 port) 2033. The electronic control unit 2010 receives signals from the various sensors 2021-2027 provided in the vehicle. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

A driving support system unit 2030 includes: various devices for providing functions of preventing accidents and reducing driver's operating loads such as a millimeter wave radar, a LIDAR (Light Detection and Ranging), a camera, a positioning locator (e. g., GNSS, etc.) , map information (e.g., high definition (HD) map, autonomous vehicle (AV) map, etc. ), a gyro system (e. g., IMU (Inertial Measurement Unit), INS (Inertial Navigation System), etc. ), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits the current signal input from the current sensor to the electronic control unit 2010 to an external device via wireless communication. In addition, the communication module 2013 also transmits to an external device via wireless communication the following signals input to the electronic control unit 2010: front and rear wheel revolution signals acquired by a revolution sensor 2022, front and rear wheel pneumatic signals acquired by a pneumatic sensor 2023, a vehicle speed signal acquired by a vehicle speed sensor 2024, an acceleration signal acquired by an acceleration sensor 2025, an accelerator pedal depression amount signal acquired by an accelerator pedal sensor 2029, a brake pedal depression amount signal acquired by a brake pedal sensor 2026, a shift lever operation signal acquired by a shift lever sensor 2027, and detection signals for detecting obstacles, vehicles, pedestrians, etc. acquired by an object detection sensor 2028.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### Note

The disclosure described above may be expressed as follows.

A first feature is a terminal including: a control unit that identifies predicted information on radio resource management of the terminal; and a transmission unit that transmits the predicted information.

A second feature is the terminal according to the first feature, wherein the predicted information includes one or more selected from predicted information on a cell quality, predicted information on a beam quality, predicted information on a terminal trajectory, predicted information on a future cell trajectory, predicted information on a target cell, predicted information on a target beam, predicted information on a candidate target cell, predicted information on activation or deactivation of a candidate target cell, predicted information on an antenna direction, predicted information on a beam direction, predicted information on a measurement target beam, predicted information on a measurement gap length, or predicted information on a measurement gap period.

A third feature is the terminal according to the first feature or the second feature, wherein the transmission unit transmits the predicted information periodically at a specific period, transmits the predicted information in response to a request, or transmits the predicted information in response to a specific event.

A fourth feature is a base station including: a control unit that assumes that a terminal identifies predicted information on radio resource management of the terminal; and a reception unit that receives the predicted information.

A fifth feature is a radio communication system including: a terminal; and a base station, wherein the terminal includes: a control unit that identifies predicted information on radio resource management of the terminal; and a transmission unit that transmits the predicted information.

A sixth feature is a radio communication method including: a step A of identifying predicted information on radio resource management of a terminal; and a step B of transmitting the predicted information.

### REFERENCE SIGNS LIST

10 Radio communication system
20 NG-RAN
100 gNB
110 Reception unit
120 Transmission unit
130 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input device
1006 Output device
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port

1. A terminal comprising:
a control unit that identifies predicted information on radio resource management of the terminal; and
a transmission unit that transmits the predicted information.

2. The terminal according to claim 1, wherein the predicted information includes one or more selected from predicted information on a cell quality, predicted information on a beam quality, predicted information on a terminal trajectory, predicted information on a future cell trajectory, predicted information on a target cell, predicted information on a target beam, predicted information on a candidate target cell, predicted information on activation or deactivation of a candidate target cell, predicted information on an antenna direction, predicted information on a beam direction, predicted information on a measurement target beam, predicted information on a measurement gap length, or predicted information on a measurement gap period.

3. The terminal according to claim 1, wherein the transmission unit transmits the predicted information periodically at a specific period, transmits the predicted information in response to a request, or transmits the predicted information in response to a specific event.

4. A base station comprising:
a control unit that assumes that a terminal identifies predicted information on radio resource management of the terminal; and
a reception unit that receives the predicted information.

5. A radio communication system comprising:
a terminal; and
a base station, wherein the terminal includes:
a control unit that identifies predicted information on radio resource management of the terminal; and
a transmission unit that transmits the predicted information.

6. A radio communication method comprising:
a step A of identifying predicted information on radio resource management of a terminal; and
a step B for transmitting the predicted information.
